(19) United States
(12) Patent Application Publication
(10) Pub. No.: US 2025/0222727 A1
(43) Pub. Date: Jul. 10, 2025

(54) METHODS, APPARATUSES AND COMPUTER PROGRAM PRODUCTS FOR DETERMINING THE SEVERITY OF A DEFLATION OF A TIRE

(71) Applicant: NIRA Dynamics AB, Linköping (SE)

(72) Inventors: Rickard Karlsson, Linköping (SE); Joakim Wärjerstam, Linköping (SE); Erik Sköld, Linköping (SE); Anders Svensson, Ljungsbro (SE)

(21) Appl. No.: 18/853,706

(22) PCT Filed: May 5, 2023
(86) PCT No.: PCT/EP2023/061921

§ 371 Date: Oct. 2, 2024

(30) Foreign Application Priority Data
May 5, 2022 (DE) 10 2022 111 116.4

(51) Int. Cl. B60C 23/06

(52) U.S. Cl. CPC B60C 23/061

(57) ABSTRACT

Methods, apparatuses and computer program products for determining the severity of a deflation of a tire are disclosed. The method comprises: receiving wheel speed signals from wheel speed sensors; determining a first indicator value based on the received wheel speed signals, wherein the first indicator value is indicative of at least one tire-related quantity; determining whether the first indicator value satisfies a first condition; outputting, in response to determining that the first indicator value satisfies the first condition, a preliminary deflation alarm; recording, in response to determining that the first indicator value satisfies the first condition, the first indicator value; determining a second condition from at least the recorded first indicator value; determining a second indicator value based on the received wheel speed signals, wherein the second indicator value is indicative of at least one tire-related quantity; determining whether the second indicator value satisfies the determined second condition; and outputting, in response to determining that the second indicator value satisfies the second condition, a severe deflation alarm.

### TECHNICAL FIELD OF THE INVENTION

The present invention generally relates to the area of tire pressure monitoring of a number of tires in a vehicle, and in particular to methods, apparatuses and computer program products for determining the severity of a deflation of a tire.

### BACKGROUND OF THE INVENTION

Tire pressure monitoring systems (TPMS) are an important part of modern vehicles and contribute to constantly improving road safety by warning vehicle drivers of deviations of the tire pressure from nominal values.

The most straightforward implementations of such tire pressure monitoring systems use signals coming from physical pressure sensors usually located on the inside of valves and are therefore referred to as direct tire pressure monitoring systems (dTPMS).

In contrast with this, there are also implementations which determine the tire pressure from signals originating from sensors other than physical pressure sensors. Such implementations of tire pressure monitoring systems are referred to as indirect tire pressure monitoring systems (iTPMS).

Typically, iTPMS use for their estimations signals from existing sensors measuring, for instance, the angular velocity of the wheels, which are regularly used by anti-lock braking systems (ABS). Based on angular velocity signals, the systems may calculate changes in the wheel radii or determine the spectrum of the angular velocity signals as a function of the sampling frequency. From this, in turn, the system may deduce information about the tire pressures of a number of tires as well as deviations from nominal values.

While current iTPMS are able to detect tire pressure deviations from pre-defined nominal values, they cannot distinguish between different tire pressure deviating scenarios. In other words, current iTPMS are incapable of determining the severity of tire pressure deviations.

This incapability of current iTPMS to determine the severity of a tire pressure deviation from nominal values may cause vehicle drivers, in response to receiving a tire pressure warning, to immediately stop driving although the tire pressure deviation would have allowed reaching the nearest service or petrol station. While on open stretches of road with little traffic this may primarily cause inconveniences, abrupt braking from high velocities or even stopping in heavy traffic that is not absolutely necessary poses a major safety risk both to the vehicle occupants as well as to other road users. Conversely, a vehicle driver might be tempted, caused by a tire pressure warning, to try to reach the nearest service or petrol station in order to avoid immediate stopping, but unaware of the severity of the tire pressure deviation. In both cases, the lack of information regarding the severity of the tire pressure deviation may pose serious safety risks.

To reduce the probability of misjudgements regarding the severity of tire pressure deviations, there is a need for tire pressure warnings at different severity levels.

### SUMMARY OF THE INVENTION

Methods, apparatuses and computer program products are disclosed. To address the shortcomings of the type mentioned above, the present invention provides for methods, apparatuses and computer program products according to the independent claims. The dependent claims set out preferred embodiments.

According to the invention, a method for determining the severity of a deflation of a tire comprises: (i) receiving wheel speed signals from wheel speed sensors; (ii) determining a first indicator value based on the received wheel speed signals, wherein the first indicator value is indicative of at least one tire-related quantity; (iii) determining whether the first indicator value satisfies a first condition; (iv) outputting, in response to determining that the first indicator value satisfies the first condition, a preliminary deflation alarm and recording, in response to determining that the first indicator value satisfies the first condition, the first indicator value; (v) determining a second condition from at least the recorded first indicator value; (vi) determining a second indicator value based on the received wheel speed signals, wherein the second indicator value is indicative of at least one tire-related quantity; (vii) determining whether the second indicator value satisfies the determined second condition; (viii) outputting, in response to determining that the second indicator value satisfies the second condition, a severe deflation alarm.

According to an embodiment, a method may comprise receiving wheel speed signals from wheel speed sensors continuously or repeatedly.

According to an embodiment, a method may comprise that indicator values indicative of at least one tire-related quantity are determined continuously or repeatedly based on continuously or repeatedly received wheel speed signals.

According to an embodiment, a method may comprise that determining whether the first indicator value satisfies the first condition consists in comparing of a first indicator value to at least one first threshold value.

According to an embodiment, a method may comprise that determining whether the first indicator value satisfies the first condition consists in successively comparing the first indicator value to multiple first threshold values.

According to an embodiment, a method may comprise that determining whether the second indicator value satisfies the second condition consists in comparing the second indicator value to at least one second threshold value.

According to an embodiment, a method may comprise that determining whether the second indicator value satisfies the second condition consists in successively comparing the second indicator value to multiple second threshold values.

According to an embodiment, a method may comprise that determining whether the change in the rate of change of the determined indicator values over time satisfies a third condition. In other words, such embodiments may determine whether the second time derivative (or an estimate thereof) of the determined indicator values satisfies a third condition.

According to an embodiment, a method may comprise determining whether the change in the rate of change of the continuously or repeatedly determined indicator values over time satisfies a third condition consists in comparing the change in the rate of change of the continuously or repeatedly determined indicator values over time to a sequence of third threshold values.

According to an embodiment, a method may comprise that in response to determining that the change in the rate of change of the continuously or repeatedly determined indicator values over time satisfies a third condition, an alarm is issued.

According to an aspect of the invention, a computer program product includes program code configured to carry out, when executed in a computing device, the steps of one of the methods above.

According to another aspect of the invention, an apparatus for determining the severity of a deflation of a tire comprises a processing part configured to carry out the steps of the methods above.

### BRIEF DESCRIPTION OF THE DRAWINGS

The invention is described with reference to the accompanying drawings in which:

FIG. 1 shows a schematic flow diagram of the method for determining the severity of a deflation of a tire according to the invention.

FIG. 2 shows a schematic diagram of an embodiment of an apparatus according to embodiments.

FIG. 3A shows an exemplary graphical implementation of a preliminary deflation alarm.

FIG. 3B shows an exemplary graphical implementation of a severe deflation alarm.

FIG. 4 shows an illustrative time course of output signals of the WRA module 205 of FIG. 2 for a constellation where in only one wheel (1W) a tire pressure deviation from nominal values is detected.

FIG. 5 shows signals representing the time development of tire pressures corresponding to four wheels.

FIG. 6 shows an illustrative time course of output signals of the WRA module 205 of FIG. 2 for a constellation where in two wheels (2W) a tire pressure deviation from nominal values is detected.

FIG. 7 shows an illustrative time course of output signals of the WSA module 204 of FIG. 2 for a 1W pressure deviating tire constellation.

FIG. 8 shows an illustrative time course of output signals of the WSA module 204 of FIG. 2 for a 2W pressure deviating tire constellation.

### DETAILED DESCRIPTION

Indirect tire pressure monitoring is a technique known to the person skilled in the art from general knowledge and pertinent literature. Details of this technique are therefore only described as far as they directly concern the present disclosure.

In order to be able to output tire pressure warnings at different severity levels, the severity of a tire pressure deviation from a nominal value has to be determined. This, in turn, may be achieved by (e.g., continuously) monitor the development of indicator values (indicative of the tire pressure) in the course of time, to check whether the tire pressure satisfies certain conditions and to adjust these conditions by taking into account information relating to vehicle and driving conditions (including, for example, vehicle velocity, wheel angular velocities of one or more wheels, load information, load distribution information, tire temperature of one or more wheels, ambient temperature, etc.).

The present method for determining tire pressure deviations from nominal values is not limited to one wheel, but can be simultaneously applied to any number of wheels. For reasons of comprehensibility, however, we explain the method using the example of one wheel.

Throughout the rest of the description, the term ‘continuously’ in the context of some procedure, operation or step (including, for example, monitoring, measuring, checking, adjusting, etc.) must be understood to both comprise the meaning of continuity in the rigorous mathematical sense, namely to repeat the respective procedure, operation or step with infinite frequency, as well as the meaning of continuity in the technical sense, namely to repeat the respective procedure, operation or step with some finite frequency. Further, we remark that terms describing physical quantities such as, for example, ‘tire pressure’ must be understood to mean, depending on the context, either the physical quantity itself or the value of the physical quantity. Finally, the terms ‘time development’ and ‘development in the course of time’ will be used interchangeably throughout the description.

In order to comply with legal requirements, any tire pressure monitoring system must issue a warning in response to the tire pressure of one or more wheels falling short of certain legally defined, load-dependent thresholds. In other words, the development of the tire pressure of a wheel in the course of time has no relevance whatsoever for the issuing of a tire pressure warning as per current legal requirements.

As a consequence of this, two situations such as a rapid tire pressure loss leading to a sharp undershooting of the legally defined threshold and a prolonged, gradual decline in tire pressure leading to a slight shortfall below the legally defined threshold lead to the same tire pressure warning according to conventional methods, although the two situations are fundamentally different with regard to severity of the deflation: While the first situation is an example for a serious safety risk and thus calls for an immediate stop, the second situation might allow to reach the next service point or petrol station, though possibly at reduced speed, without posing serious safety risks.

The present invention resolves this issue and allows to distinguish between different tire deflation situations. For instance, it may be implemented by not only comparing the tire pressure with legally-defined, load-dependent, fixed thresholds, but continuously monitoring the tire pressure and checking whether certain conditions are satisfied. In the following paragraphs the individual steps of the method for determining the severity of a deflation of a tire are described in detail.

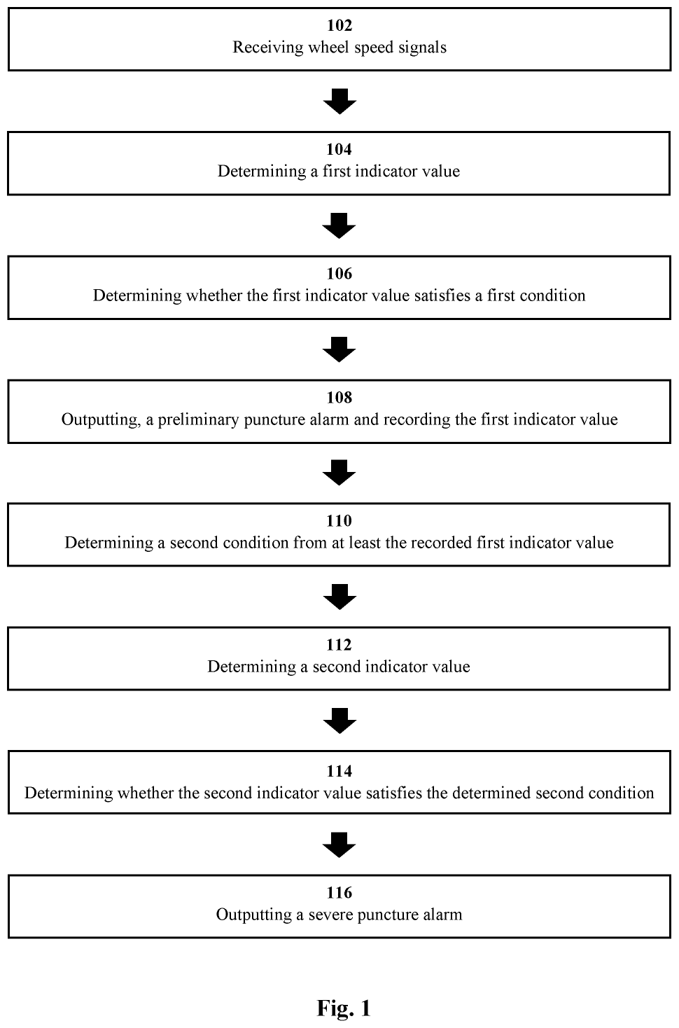

Referring to FIG. 1, the starting point of the method is given by wheel speed signals received from wheel speed sensors at step 102. In typical embodiments, the wheel speed signals contain information on the wheel angular velocity as regularly used, for instance, in an anti-lock braking system (ABS). Given these wheel speed signals, a first indicator value indicative of at least one tire-related quantity is determined at step 104. Examples of such tire-related quantities include tire pressure or quantities indicative of tire pressure, such as the output from a wheel radius analysis or a wheel spectrum analysis. To this end, the wheel speed signals are processed by one or more analysis modules which perform, for example, a wheel radius analysis (WRA) and/or a wheel spectrum analysis (WSA). From the inferred WRA data and/or WSA data, a first indicator value indicative of a tire-related quantity such as, for example, the tire pressure can be determined. In addition to the WRA data and/or WSA data, further data such as, for example, data relating to vehicle or driving conditions (including, for example, vehicle velocity, load information, tire temperature, ambient temperature, etc.) may also be provided by further sensors and utilized in determining a first indicator value indicative of a tire-related quantity.

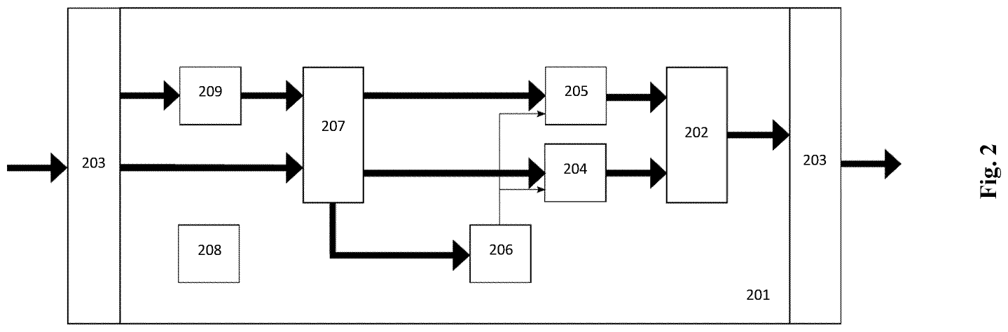

Referring to FIG. 2, the WRA and WSA modules mentioned above may be part of a tire pressure monitoring system (TPMS) 201 which may, for example, be a standardised software component integrated in an electronic control unit of a vehicle. The system 201 may be an embodiment of the apparatus according to the invention. The system 201 obtains data by means of an application program interface (API) 203. These obtained data may include, on the one hand, signals from the vehicle CAN bus etc., e.g., describing temperature changes, driving situations (speed, braking, etc.), road conditions or control commands from external devices. In order to make those signals available to the modules of system 201, they are stored according to the illustrated embodiment in a memory unit 209. On the other hand, the obtained data may include measuring data directly obtained from the vehicle's sensors, such as rotational speed sensors (as existent in the vehicle's ABS) which indicate the angular velocity of the rotating wheels.

A diagnosis control module 208 performs internal system and input signal checks and sets system status and error codes. If a severe input signal error occurs, this module can disable the tire pressure monitoring system.

The obtained data are input to a signal pre-processing module 207 which pre-filters signals in order to remove disturbances and offsets and pre-computes signals and quantities used by other modules.

Then, the pre-processed signals output by the signal pre-processing module 207 are input to a unit for roll radius based indirect tire pressure monitoring, here exemplary in form of a wheel radius analysis (WRA) module 205, and to a wheel spectrum analysis (WSA) module 204. Optionally, information is input to the WRA module 205 and the WSA module 204 informing about special driving conditions (e.g., driving with snow chains etc.) detected by a dynamic state detector 206 based on data from the signal pre-processing module 207 which will be considered for the data analysis.

In essence, a WRA as executed in the WRA module 205 is based on the fact that the wheel speed of a wheel depends on the respective wheel radius: the wheel speed increases with decreasing wheel radius. Changes in the wheel radii contain information about changes in the tire pressure of the corresponding wheels, but may also reflect vehicle load changes and surface changes or react on driving forces (acceleration, braking, forces in curves etc.).

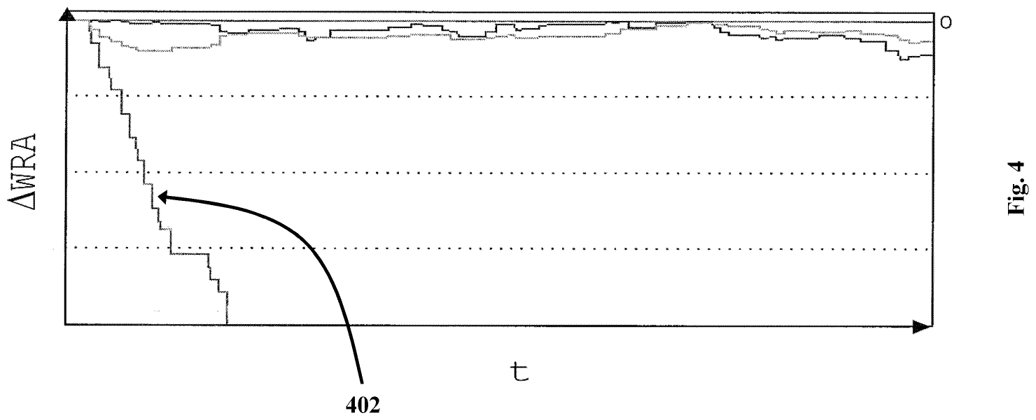

Based on the wheel angular velocity signals obtained from module 207, the WRA module 205 estimates changes in the relative wheel radii in one, two and three wheels, but not in all four tires simultaneously since the approach mostly relies on relative wheel radius estimates rather than absolute ones. In order to obtain wheel radius estimates for each wheel separately, the depicted WRA module 205 transforms the relative wheel radii into wheel individual radius estimates and outputs the wheel individual deviation of those estimates from the calibration values. Exemplary time courses of such indicator values will be described further below with reference to FIGS. 4-9.

Returning to FIG. 1 and having determined at step 104 a first indicator value indicative of a tire-related quantity such as, for example, the tire pressure, at step 106 it is determined whether the first indicator value satisfies a first condition. For instance, the first indicator value may be considered to satisfy a first condition when, upon insertion of the first indicator value into a mathematical equation, the resulting value lies in a certain range. One of the simplest forms of such a condition is, for example, to compare the first indicator value (denoted, without loss of generality, by ‘x’ throughout the rest of the description) with some threshold (denoted, without loss of generality, by ‘t_1’ throughout the rest of the description) and to determine whether the first indicator value is greater than (x>t_1), less than (x<t_1) or equal to (x=t_1,e.g., within a certain error margin) the threshold. Instead of a single threshold, the condition may involve the comparison to a range, i.e., whether the indicator value lies within the range or outside of the range. More involved implementations of such conditions may comprise analytical or numerical solving of different kinds of mathematical equations, including, for example, differential equations, partial differential equations and implicit equations.

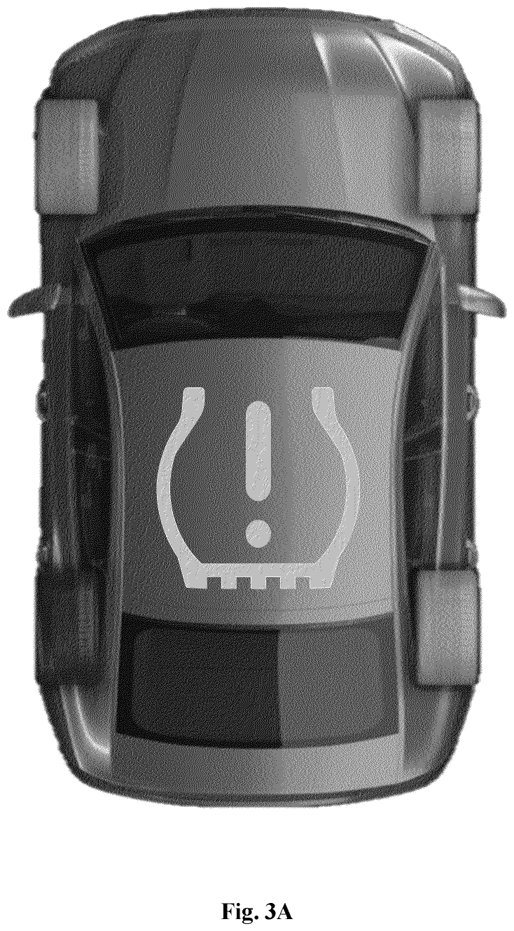

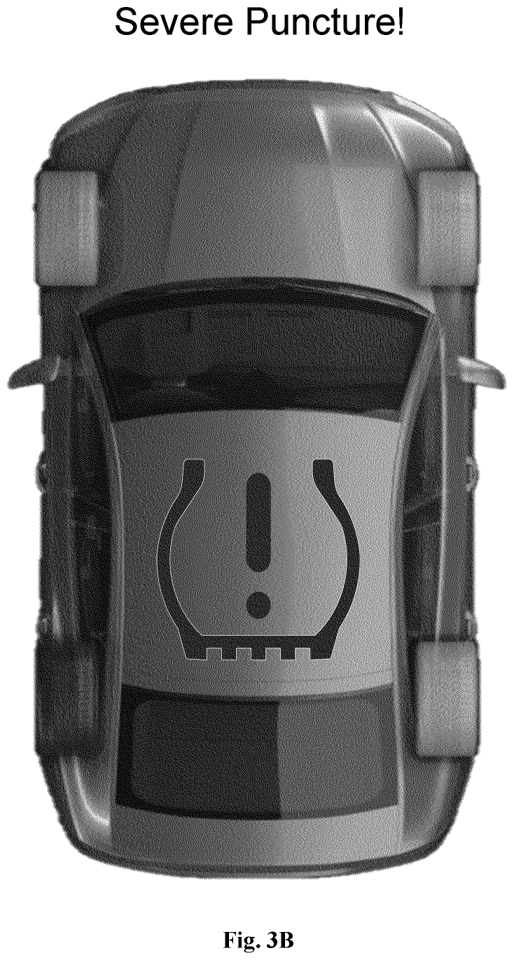

Next, at step 108, in response to determining that the first indicator value satisfies a first condition, a preliminary alarm is output (see left-hand part of FIG. 3) and the first indicator value for which the first condition is satisfied (denoted, without loss of generality, by ‘x_1’ throughout the rest of the description) is recorded and stored in an internal memory for further use. In cases where the first indicator value corresponding to some tire-related quantity represents a tire pressure, the preliminary alarm indicates a tire pressure lying outside a certain range whose values are considered to represent nominal tire pressures. In tire deflation scenarios, the lower boundary of the range of tire pressures considered as nominal may coincide with one of the legally required threshold values. In this case, the preliminary alarm coincides with the legally required low tire pressure warning. In other implementations, however, the preliminary alarm may be issued before or after the legally required low tire pressure warning is activated.

The first indicator value x_1 stored in the previous step 108 is utilized in step 110 to determine a second condition. Similar to the first condition, also the second condition must be understood to mean some mathematical equation which may have a functional dependence on the stored first indicator value x_1 as well as on values of other tire-related or vehicle-related quantities (including, for example, vehicle velocity, load information, tire temperature, ambient temperature, etc.). More involved implementations of such a condition may comprise analytical or numerical solving of different kinds of mathematical equations, including, for example, differential equations, partial differential equations or implicit equations. For instance, if the second condition is represented by a x_1-dependent threshold, it might be computed from x_1according to r*x_1 with r being a numerical factor.

Afterwards, at step 112, a second indicator value indicative of at least one tire-related quantity is determined from the received wheel speed signals. In typical embodiments, the wheel speed signals contain information on the wheel angular velocity as regularly used, for instance, in an anti-lock braking system (ABS). These received wheel speed signals are processed by one or more analysis modules which perform, for example, a wheel radius analysis (WRA) and/or a wheel spectrum analysis (WSA). From the inferred WRA data and/or WSA data, a second indicator value indicative of a tire-related quantity such as, for example, the tire pressure value can be determined. In addition to the WRA data and/or WSA data, further data such as, for example, data relating to vehicle or driving conditions (including, for example, vehicle velocity, load information, tire temperature, ambient temperature, etc.) may also be provided by further sensors and utilized in determining a second indicator value indicative of a tire-related quantity. In typical embodiments, both the first and second indicator value are indicative of the same tire-related quantity which may be the tire pressure at different points in time. In other embodiments, however, the second indicator value may be indicative of a quantity different than the first indicator value.

Subsequently, at step 114, the determined second indicator value indicative of a tire-related quantity such as, for example, the tire pressure, is used to determine whether the second indicator value satisfies the second condition. In this context, the term ‘the second indicator value satisfies the second condition’ must be understood to mean that, upon insertion of the second indicator value into a mathematical equation, the resulting value lies in a certain range. One of the simplest forms of such a condition is, for example, to compare the second indicator value (denoted, without loss of generality, by ‘y’ throughout the rest of the description) with some value of a possibly x_1-dependent quantity (denoted, without loss of generality, by C(x_1) throughout the rest of the description) and to determine whether the second indicator value is greater than (y>C(x_1)), less than (y<C (x_1)) or equal to (y=C(x_1)) the value of the possibly x_1-dependent quantity C(x_1). The chosen notation C(x_1) shall be understood such as to indicate that the second condition may take the recorded first indicator value x_1 as input. However, also other choices such as, for example, C(x_1)=m*x_1 (with some multiplicative constant denoted by ‘m’), C(x_1)=x_1 +a (with some additive constant denoted by ‘a’) and combinations therefore are admissible. Further, the multiplicative and additive constants may themselves have some functional dependence on vehicle-dependent and/or tire-related quantities.

Finally, at step 116, in response to determining that the second indicator value satisfies the second condition, the preliminary alarm (see FIG. 3A) is withdrawn and instead a severe alarm (see FIG. 3B) is output. In tire deflation scenarios, that is when both the first and the second indicator value represent a tire pressure, the severe alarm indicates a tire pressure not only lying outside a first range of values considered as nominal tire pressures according to the first condition, but also lying outside a second range of values considered as non-nominal though at least temporarily acceptable. In other words, a severe alarm is output in response to a tire pressure falling short a pressure level even below the one associated with the preliminary alarm.

FIG. 3A shows an exemplary graphical implementation of a preliminary deflation alarm.

FIG. 3B shows an exemplary graphical implementation of a severe deflation alarm which differs from the preliminary alarm shown in FIG. 3A by an additional warning text and possibly different colours.

FIG. 4 shows an exemplary time course of signals output by one embodiment of a WRA module 205 for an illustrative constellation where in only one wheel (1W) a tire pressure deviation from nominal values is detected. One of the output signals is constantly zero, because a normalisation is carried out by the WRA module 205 such that the signal corresponding to the tire with the least probability of having a pressure drop is set to zero. The other signals indicate estimations of an individual tire's pressure deviation with regard to the calibration values.

As can be seen, the course of signal 402 clearly denoted an increasing estimated pressure deviation of its corresponding tire.

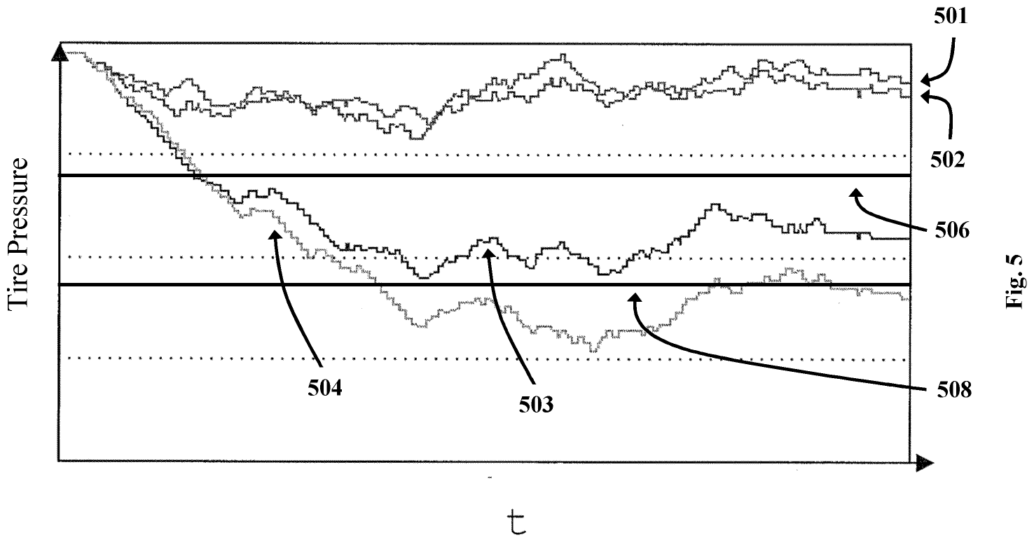

FIG. 5 shows signals 501, 502, 503, 504 representing the time development of tire pressures corresponding to four wheels. As can be seen, the two signals 501 and 502 show a slight initial decrease, but quickly converge to a common constant value (except for measurement-related fluctuations). In contrast with this, the signals 503 and 504 show a steep initial decrease and both fall short a first threshold 506 within a short period of time. As described further above, the first threshold 506 is one possible implementation of the first condition.

In response to the signals 503 and 504 falling short of the first threshold 506, the corresponding tire pressure value (being a concrete implementation of the stored indicator value x_1) is stored and subsequently used for determining a second condition which, in the current implementation, is implemented as a second threshold 508.

In the further course of time, the steep decrease of signal 503 flattens and the signal starts converging against some constant value above the dynamically determined threshold 508 which depends on the pressure value corresponding to the first threshold 506. Signal 504, however, even falls short of the dynamically determined threshold 508 before it also starts to stabilize. In an embodiment, threshold 506 may correspond to a preliminary deflation alarm while threshold 508 may correspond to a severe deflation alarm.

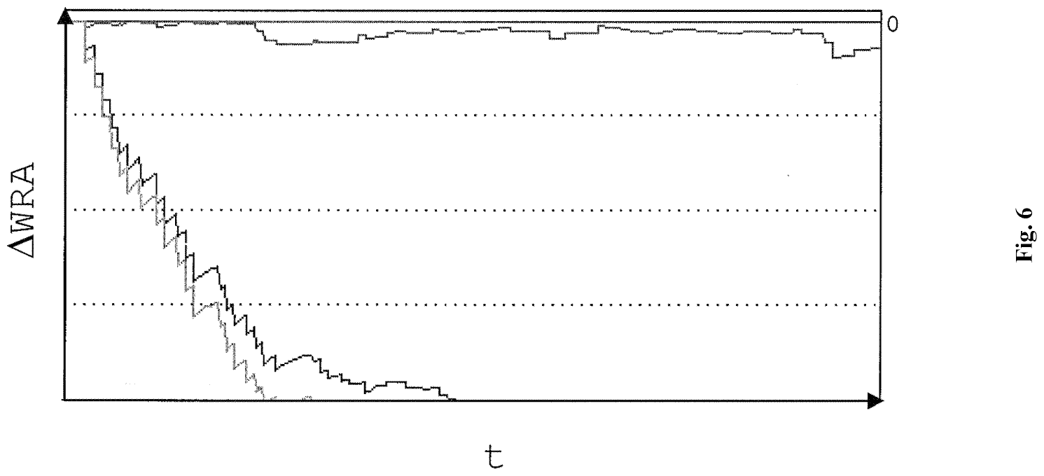

FIG. 6 depicts the WRA signal output for an illustrative constellation where in two wheels (2W) a tire pressure deviation from nominal values is detected. Again, the two signals corresponding to the concerned tires denote an increasing estimated pressure deviation.

The WSA module 204 detects changes in the spectral properties of each of the four wheel angular velocity signals. The tire pressure has significant influence on the characteristics of the spectrum of the angular velocity signal; however, the road surface and the ambient temperature also have an impact on the angular velocity signal spectrum and should be considered.

By first calculating a parametric model of the wheel velocity spectrum and using the parameters of this model to calculate a spectral shape factor that condenses the different pressure dependent features of the spectrum into one single scalar quantity, the WSA module 204 detects in the illustrated embodiment changes in the tire pressure for each wheel individually.

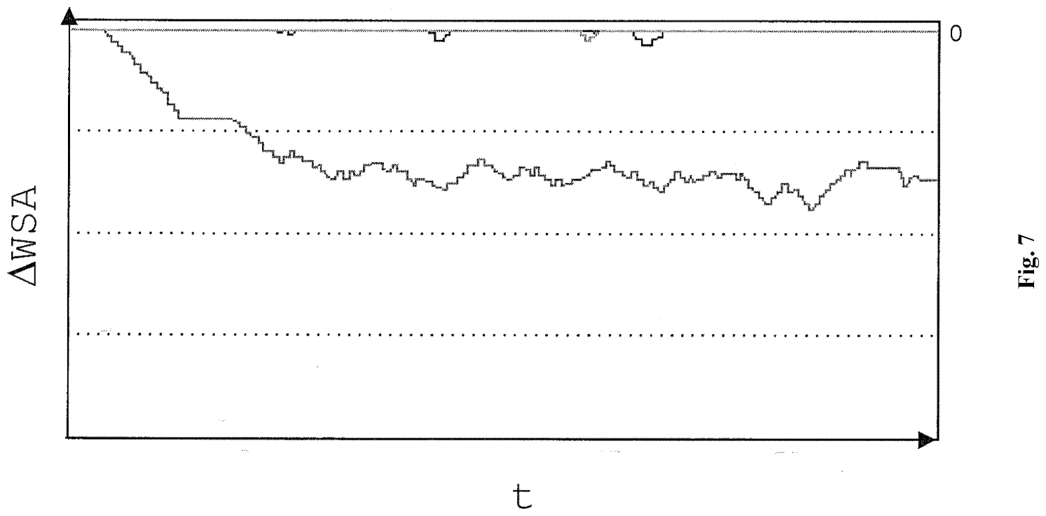

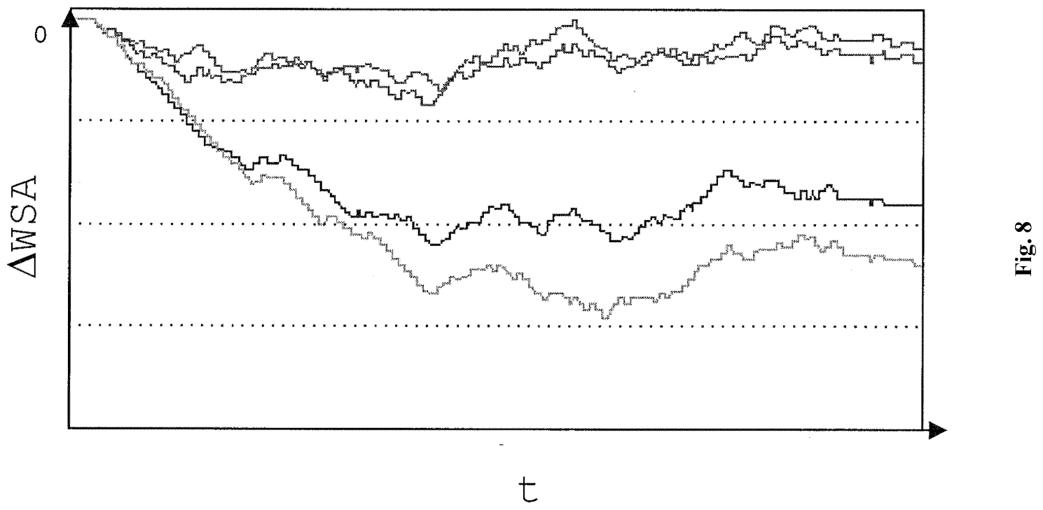

FIGS. 7 and 8 show the temporal course of illustrative output signals of the WSA module 204 for a 1W pressure deviating tire constellation and a 2W pressure deviating tire constellation. Each signal indicates the estimated pressure deviation of a particular tire with regard to the calibration values. In contrast to the WRA module 205, the WSA module 204 does not carry out a normalisation of the signal representing the tire with the least pressure deviation.

As can be seen, the WSA signals indicate pressure drops of the concerned tires for all of the above constellations; however, the indicated deviation from the “normal” signal levels is not as significant as those of the WRA signals.

What is claimed is:

1. Method A method for determining the severity of a deflation of at least one tire, the method comprising:
receiving wheel speed signals from at least one wheel speed sensor;
determining a first indicator value based on the received wheel speed signals, wherein the first indicator value is indicative of at least one tire-related quantity;
determining whether the first indicator value satisfies a first condition;
outputting, in response to determining that the first indicator value satisfies the first condition, a preliminary deflation alarm;
recording, in response to determining that the first indicator value satisfies the first condition, the first indicator value;
determining a second condition from at least the recorded first indicator value;
determining a second indicator value based on the received wheel speed signals, wherein the second indicator value is indicative of at least one tire-related quantity;
determining whether the second indicator value satisfies the determined second condition; and
outputting, in response to determining that the second indicator value satisfies the second condition, a severe deflation alarm.

2. A method according to claim 1, wherein said wheel speed signals are received continuously or repeatedly from a wheel speed sensor.

3. A method according to claim 2, wherein said indicator values indicative of at least one tire-related quantity are determined continuously or repeatedly based on said continuously or repeatedly received wheel speed signals.

4. A method according to claim 1, wherein determining whether the first indicator value satisfies the first condition comprises comparing the first indicator value to at least one first threshold value.

5. A method according to claim 4, wherein determining whether the first indicator value satisfies the first condition comprises successively comparing the first indicator value to multiple first threshold values.

6. A method according to claim 1, wherein determining whether the second indicator value satisfies the second condition comprises comparing the second indicator value to at least one second threshold value.

7. A method according to claim 6, wherein determining whether the second indicator value satisfies the second condition comprises comparing the second indicator value to multiple second threshold values.

8. A method according to claim 1, wherein it is determined whether a change in the rate of change of the determined indicator values over time satisfies a third condition.

9. A method according to claim 8, wherein determining whether the change in the rate of change of the determined indicator values over time satisfies a third condition comprises comparing the change in the rate of change of the determined indicator values over time to a sequence of third threshold values.

10. A method according to claim 8, wherein, in response to determining that the change in the rate of the determined indicator values over time satisfies a third condition, issuing an alarm.

11. A computer program product including program code configured to cause, when executed in a computing device, the computing device to perform operations that include:
receiving wheel speed signals from at least one wheel speed sensor;
determining a first indicator value based on the received wheel speed signals, wherein the first indicator value is indicative of at least one tire-related quantity;
determining whether the first indicator value satisfies a first condition;
outputting, in response to determining that the first indicator value satisfies the first condition, a preliminary deflation alarm;
recording, in response to determining that the first indicator value satisfies the first condition, the first indicator value;
determining a second condition from at least the recorded first indicator value;
determining a second indicator value based on the received wheel speed signals, wherein the second indicator value is indicative of at least one tire-related quantity;
determining whether the second indicator value satisfies the determined second condition; and
outputting, in response to determining that the second indicator value satisfies the second condition, a severe deflation alarm.

12. (canceled)

13. A computer program product according to claim 11, wherein said wheel speed signals are received continuously or repeatedly from a wheel speed sensor.

14. A computer program according to claim 13, wherein said indicator values indicative of at least one tire-related quantity are determined continuously or repeatedly based on said continuously or repeatedly received wheel speed signals.

15. A computer program according to claim 11, wherein determining whether the first indicator value satisfies the first condition comprises comparing the first indicator value to at least one first threshold value.

16. A computer program product according to claim 15, wherein determining whether the first indicator value satisfies the first condition comprises successively comparing the first indicator value to multiple first threshold values.

17. An apparatus for determining a severity of a deflation of at least one tire, the apparatus comprising:
a processing part configured to perform operations comprising:
receiving wheel speed signals from at least one wheel speed sensor;
determining a first indicator value based on the received wheel speed signals, wherein the first indicator value is indicative of at least one tire-related quantity;
determining whether the first indicator value satisfies a first condition;
outputting, in response to determining that the first indicator value satisfies the first condition, a preliminary deflation alarm;
recording, in response to determining that the first indicator value satisfies the first condition, the first indicator value;
determining a second condition from at least the recorded first indicator value;
determining a second indicator value based on the received wheel speed signals, wherein the second indicator value is indicative of at least one tire-related quantity;
determining whether the second indicator value satisfies the determined second condition; and
outputting, in response to determining that the second indicator value satisfies the second condition, a severe deflation alarm.

18. An apparatus claim 17, wherein said wheel speed signals are received continuously or repeatedly from a wheel speed sensor.

19. An apparatus of claim 18, wherein said indicator values indicative of at least one tire-related quantity are determined continuously or repeatedly based on said continuously or repeatedly received wheel speed signals.

20. An apparatus of claim 17, wherein determining whether the first indicator value satisfies the first condition comprises comparing the first indicator value to at least one first threshold value.

21. A computer program product according to claim 20, wherein determining whether the first indicator value satisfies the first condition comprises successively comparing the first indicator value to multiple first threshold values.
